(19) United States
(12) Patent Application Publication
(10) Pub. No.: US 2015/0310336 A1
(43) Pub. Date: Oct. 29, 2015

(54) PREDICTING CUSTOMER CHURN IN A TELECOMMUNICATIONS NETWORK ENVIRONMENT

(71) Applicant: Wise Athena Inc., San Francisco, CA (US)

(72) Inventors: Federico Castanedo Sotela, Madrid (ES); Alfonso Vazquez Elvira, Madrid (ES)

(21) Appl. No.: 14/698,046

(22) Filed: Apr. 28, 2015

Related U.S. Application Data
(60) Provisional application No. 61/985,671, filed on Apr. 29, 2014.

(51) Int. Cl. G06N 5/04; G06Q 30/02; G06N 99/00

(52) U.S. Cl. CPC G06N 5/04; G06N 99/005; G06Q 30/0202

(57) ABSTRACT

Embodiments of the present disclosure may provide a platform configured to forecast customer churn in a telecommunication network. The platform may be configured to receive customer activity data. The platform may then compute features associated with the customer activity data. These features are then inputted into a machine learning model used for predicting customer churn. Finally, the platform may then provide a report indicating customer churn predictions. The platform may be trained in a training phase prior to entering a prediction phase.

The platform may employ an ensemble of statistical machine learning classifiers. An ensemble of classifiers may comprise a set of classifiers whose individual decisions are combined to generate a final decision. An ensemble consistent with embodiments of the present disclosure may be composed by several supervised classification algorithms, including, but not limited to: random forest, neural networks, support vector machines, and logistic regression.

### RELATED APPLICATION

Under provisions of 35 U.S.C. §119(e), the Applicant claims the benefit of U.S. provisional application No. 61/985,671, filed Apr. 29, 2014 by the same inventors and applicant assigned to the present application, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to customer churn prediction technology as applied to the telecommunications network environment.

### BACKGROUND

Customer churn may be defined as the loss of a customer resulting from, for example, the customer switching to a competitor's product or service. Being able to predict customer churn in advance may provide companies with high valuable insight in order to retain and increase their customer base. Having a predicted base of ‘churners’ (e.g., customers likely to churn), a company may then employ specific commercial actions to those predicted churners with the aim of retaining the churner or, for example, reducing the likelihood that the customer will churn.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope. In the embodiments of the present disclosure, a prepaid customer may not be bound by a contract and only pays for the calls he makes. The following advantages may be observed over the current state of the art.

Embodiments of the present disclosure may provide a platform configured to forecast customer churn in a prepaid or postpaid telecommunication network. The platform may be configured to receive customer activity data. The platform may then compute features associated with the customer activity data. These features are then inputted into a machine learning model used for predicting customer churn. Finally, the platform may then provide a report indicating customer churn predictions. The platform may be trained in a training phase prior to entering a prediction phase.

Consistent with embodiments of the present disclosure, the platform for predicting customer churn may be provided by using an ensemble of statistical machine learning classifiers. An ensemble of classifiers may comprise a set of classifiers whose individual decisions are combined to generate a final decision. An ensemble consistent with embodiments of the present disclosure may be composed by several supervised classification algorithms, including, but not limited to: random forest, neural networks, support vector machines, and logistic regression.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a diagram of possible customer states based on the balance replenishment events;

FIG. 3 is a diagram of an embodiment of the training and prediction phases;

FIG. 4 is a flow chart of an embodiment of a feature preparation process;

FIG. 5 is a chart showing a receiver operating curve of the prediction results for eight different months; and

FIG. 6 is a block diagram of a system including a computing device for predicting customer churn in a telecommunications network.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosers include many aspects and features. Moreover, while many aspects and features relate to, and are described in, the context of telecommunications network environments, embodiments of the present disclosure are not limited to use only in this context. It is anticipated and contemplated that the platform disclosed herein may be applicable to, for example, but not limited to, telecommunication companies, namely that provide a monthly subscription services to mobile telecommunication devices, data network providers, virtual network providers, and any entity that may provide a telecommunications service, whether telephonic, data-based, or otherwise network related.

I. Customer Churn in Telecommunications Network

Many mobile telecommunications markets across the world are approaching saturation levels. The current focus in the telecommunications industry may be moving from customer acquisition towards customer retention. Customer churn in the prepaid mobile telecommunications business is radically different than in, for example, postpaid services.

Churn in prepaid services may be measured based on the lack of activity in the network over a period of time. This time interval may be different from one telecommunications service provider to another. As a result, there is no formal notification from the customer upon the ending of their subscription or termination of a contract term. The situation can be confusing, as in some cases the customer may use multiple SIM cards with a single device over time. Moreover, in some countries it is not mandatory for a telecommunications service provider's customer to provide personal data for the subscription to the prepaid services. Finally, in many cases, postpaid contracts have a fixed duration length (e.g., one year), so people are likely to churn when their contract is close to expiration. Accordingly, the expiration day can be used as a very reliable factor in predicting customer churn.

Given that there is no expectation of receiving a formal notice upon the termination of a customer's service contract, the actual deactivation of the service may often be performed based on the lack of customer activity. It can be understood that, before the customers actually switch from one service provider to another, the customers have already made up their mind about the transition some time before the transition actually occurs. It can be further observed that, once the customer has decided or is in the process of deciding upon the transition, the customer's mobile phone usage patterns may start to change. The sooner these changing patterns are detected the more opportunities and time the telecommunications service provider may have to try to retain the customer.

Telecommunication service providers may enable their customers to replenish their account balance (e.g., data usage balance, minutes usage balance, funding balance, and the like). Customers may replenish their balance by, for example, but not limited to, purchasing additional minutes, data, or adding funds to their account balance. Depending on balance replenishment frequency, prepaid phone customers can be divided into two disjoint sets: active customers and inactive customers.

II. Churn Prediction Platform Configuration

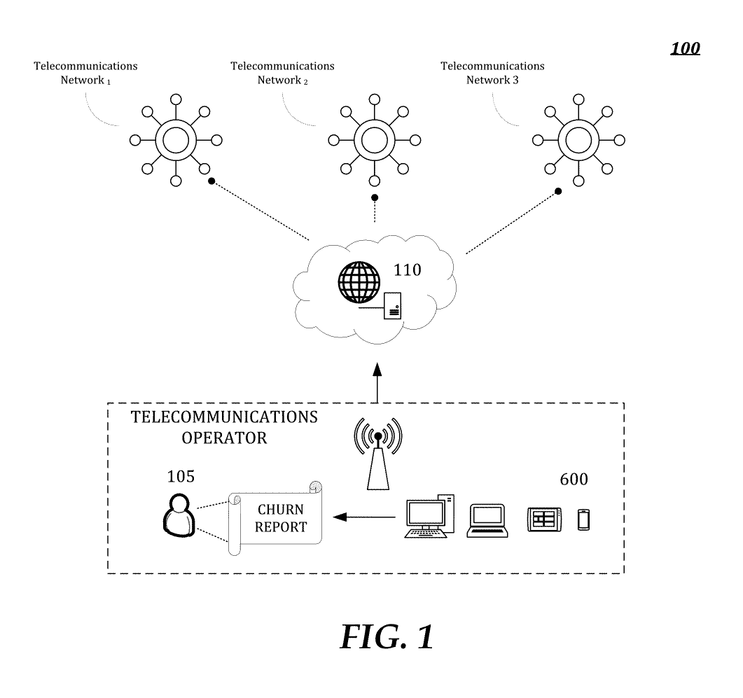

FIG. 1 illustrates one possible operating environment through which a platform consistent with embodiments of the present disclosure may be provided. By way of non-limiting example, a churn prediction platform 100 may be hosted on a centralized server 110, such as, for example, a cloud computing service. A platform administered 105 may access platform 100 through a software application. The software application may be embodied as, for example, but not be limited to, a website, a web application, a desktop application, and a mobile application compatible with a computing device 600. One possible embodiment of the software application may be provided by Wise Athena Inc.

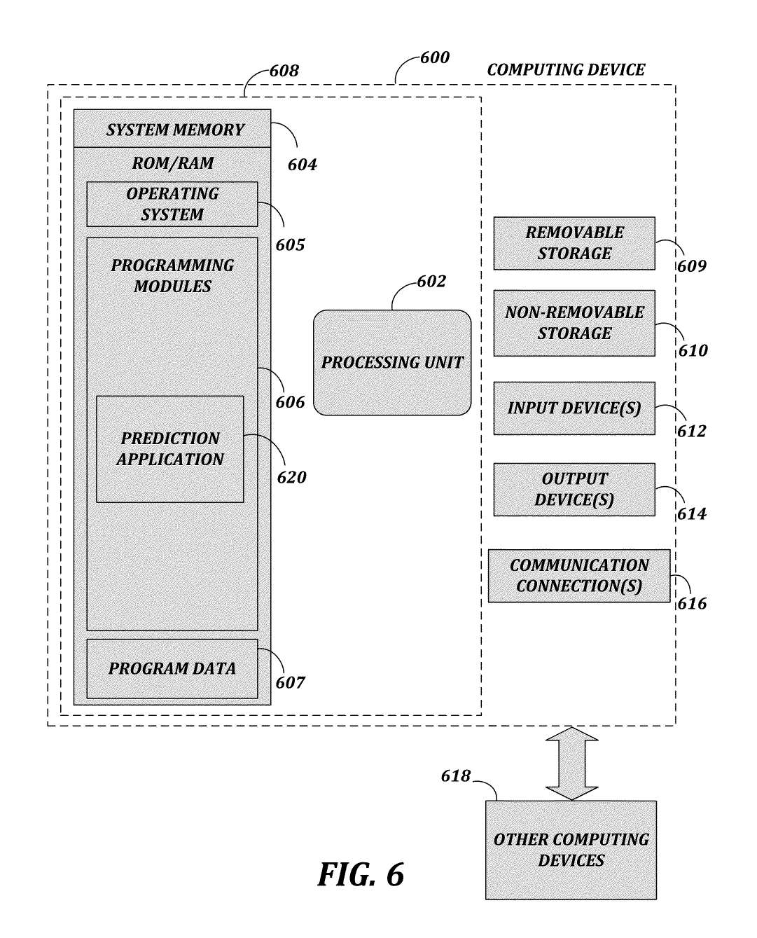

As will be detailed with reference to FIG. 6 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

Platform 100 may be deployed on with a telecommunications service provider's network. In this way, platform 100 may have access to network customer networks 1-N through which it may access and retrieve customer activity data. In turn, platform 100 may use the customer activity data to perform the churn predictions detailed in this disclosure. The result of the calculations may be provided to user 105 (e.g., telecommunications operator).

Customer networks 1-N may comprise active and inactive customers. Consistent with embodiments of the present disclosure, an active customer may be defined as the customer who has made a balance replenishment event within a specific period of time t. An inactive customer can be defined as a customer who did not make any balance replenishment event during the same period t.

Embodiments of the present disclosure are discussed with reference to telecommunication networks and telecommunication service providers. It should be understood that similar methods and systems (e.g., platform 100) may be used to predict churn in other sectors different than telecommunications. In general, any subscription or prepaid contract of a customer and a company may be susceptible of churn and may be adaptable and compatible with platform 100.

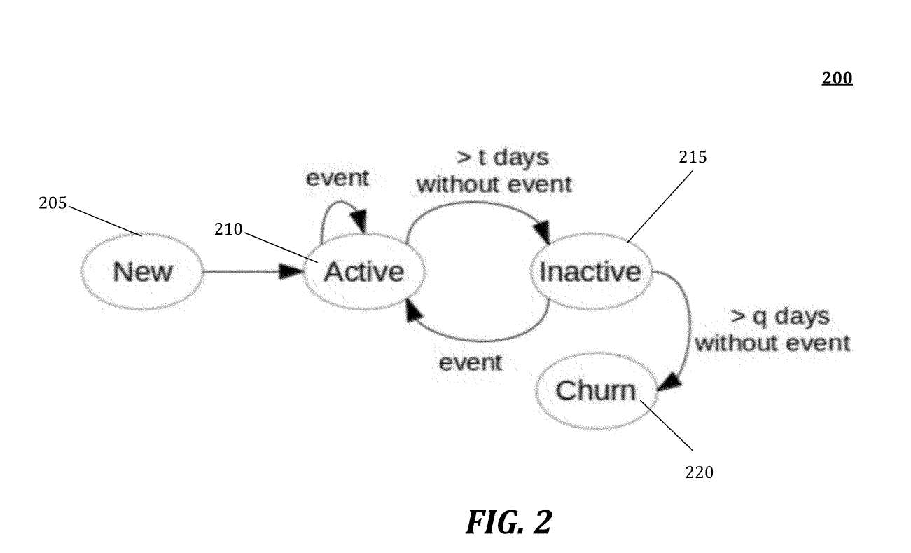

Embodiments of platform 100 may provide a specific time counter associated with each customer that carries the elapsed time between current date and last customer replenishment. The information from this counter may be used to classify the customer as active or inactive. Now with reference to FIG. 2, a common employed value for t may be, for example, 30 days. A new customer 205 in the telecommunications server provider network may enter an active state 210 by using the telecommunications service through, for example, the customer's mobile device. After t days of inactivity, customer 205 may enter an inactive state 215. After q days, the inactive customer 205 may become a churned customer 220. Platform 100 may constantly be parsing the customer data to provide potential churn customer to a telecommunications operator (e.g., user 105). Analysis of the report may result in action taken by the telecommunications service provider to retain a customer prior to churn.

III. Churn Prediction Platform Algorithms

In a plurality of scenarios, customer churn may be preceded by an inactive state 215. In order to successfully address customer churn, a highly accurate forecast for the future state (active/inactive) of the current active customers becomes paramount. Accordingly, embodiments of the present disclosure provide platform 100 for predicting customer churn based on statistical machine learning algorithms, commonly known as machine learning.

In various other embodiments, the method for predicting customer churn may be provided by using an ensemble of statistical machine learning classifiers. An ensemble of classifiers may comprise a set of classifiers whose individual decisions are combined to generate a final decision. An ensemble consistent with embodiments of the present disclosure may be composed by several supervised classification algorithms, including, but not limited to: random forest, neural networks, support vector machines, and logistic regression.

It should be noted, however, that the method does not need to employ all of these components. For example, a method consistent with embodiments of the present disclosure may only employ the random forest algorithm. The ensemble of classifiers, however, may further extend and improve the accuracy of the method.

A. Random Forest

In some embodiments, a random forest algorithm may be employed by platform 100. A random forest algorithm may be composed of hundred or even several thousands of different decision trees. Each decision tree may be generated from a random selection of a subset of m predictors or input features using a sample of the training set.

B. Neural Network

A neural network may comprise a classification algorithm based on the ideas of how the human brain works. In the method consistent with embodiments disclosed herein, a neural network may be trained by a supervised learning mechanism in an iterative way using the backpropagation algorithm with the error among the predictions and the truth as a cost function.

C. Support Vector

A support vector machine may comprise an algorithm that constructs a set of hyperplanes in high dimensional space. The optimal hyperplane can be represented in an infinite number of different ways by scaling the parameters. The training examples that are close to the hyperplane are called support vectors, which must be optimized by Langrangian optimization to obtain the optimal hyperplane.

D. Logistic Regression

A logistic regression classifier may employ the sigmoid or logistic function to perform a regression on the input data points. The logistic function is a monotonic and continually differentiable function between 0 and 1 and allows the classification between two sets.

IV. Platform Operation

Platform 100 may be configured to be applied over past training data to generate a predictive model, which is used to forecast customer state based on current customer activity data. To obtain this model, a training phase may be carried out using already known active/inactive customer states (known as groundtruth training data) and their statistical behaviors (known as customer features). When a model is already trained with groundtruth training data, it may then be used by platform 100 to predict the future state of each customer. For the prediction phase, customer activity data may first be encoded into the current features set. Then these features may be propagated into the predictive model to generate the predictions.

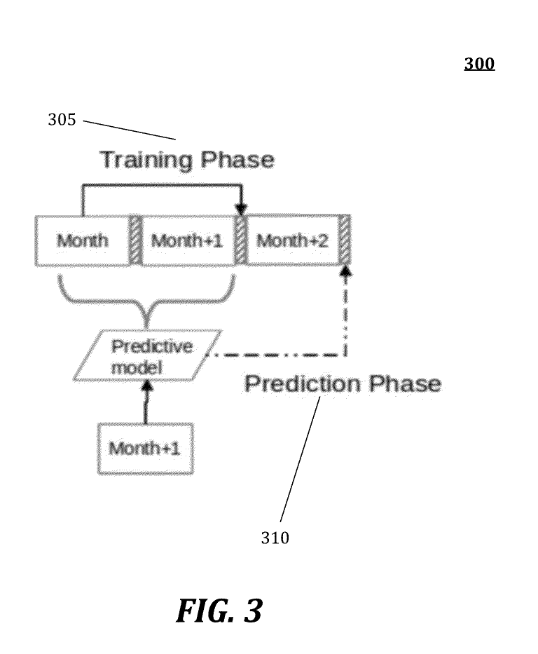

As illustrated in FIG. 3, on such method may be composed of two phases: a training phase 305 and a prediction phase 310. Both training and prediction phases 305 and 310, respectively, have similar type of inputs (known as features) but computed in different period of times. Training data may be used to learn a model and current data may be used to predict the future state of each customer. It is important to clarify that each instance in the training and predicting data may refer to different customers, so the customer identification may not, for example, be taken into consideration to generate the predictions. In that sense, predictions may be generated for new customers from their initial relationship with the service provider after the customer features are computed.

FIGS. 2-4 provide flow charts setting forth the general stages involved in methods consistent with embodiments of the disclosure for predicting customer churn. The methods may be implemented using a computing device 600 as described in more detail below with respect to FIG. 6. Ways to implement the stages of the methods will be described in greater detail below. It should be noted that the disclosed methods' stages may be modified in any manner, including by reordering stages and/or inserting or deleting stages, without departing from the invention. Moreover, methods 200-400 for predicting customer churn as disclosed herein may be comprised of multiple sub-methods.

Although methods 200-400 have been described to be performed by platform 100, it should be understood that computing device 600 may be used to perform the various stages of methods 200-400. Furthermore, in some embodiments, different operations may be performed by different networked elements in operative communication with computing device 600. For example, server 110 may be employed in the performance of some or all of the stages in methods 300 and 400. Moreover, server 110 may be configured much like computing device 600.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein.

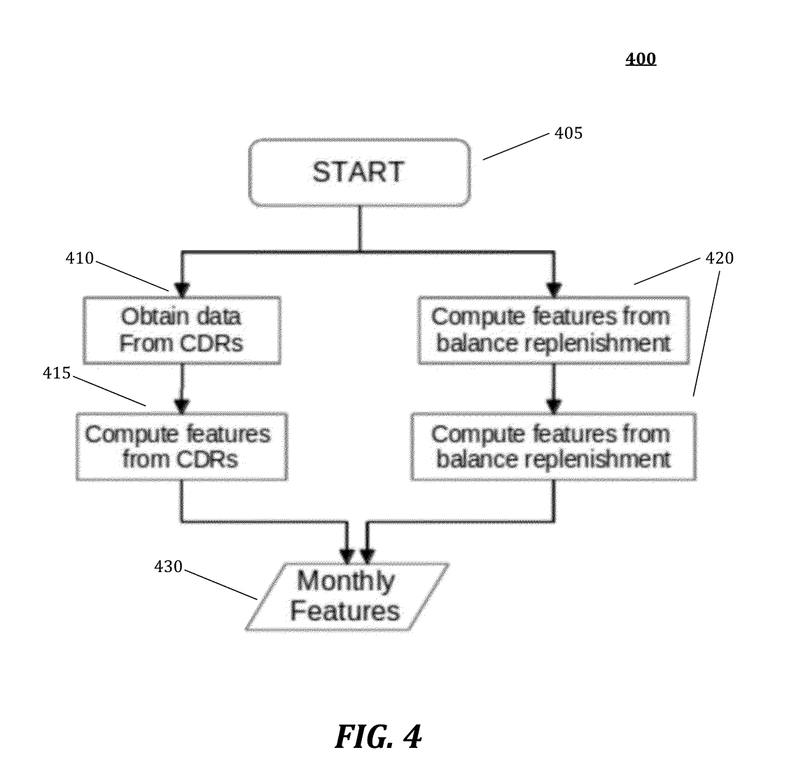

Referring now to FIG. 4, inputs to platform 100 may comprise the Call Detail Record (CDR) and the balance replenishment history of each customer. From starting block 405, method 400 may proceed to stage 410, where CDR provides platform 100 with log information. The log information may include, but not be limited to, for example, details about each call made by the customer such as from which cell tower was the call made, when the call was made, the duration of the call and so on. Platform 100 may then proceed to stage 415, where platform 100 may compute features using the CDR.

The present disclosers include many aspects and features. Moreover, while many aspects and features relate to, and are described in, the context of log information, embodiments of the present disclosure are not limited to use only in this context. It is anticipated and contemplated that the platform disclosed herein may be applicable to, for example, but not limited to, mobile data logs associated with customer mobile devices, personally identifiable information (PII), non-PII, customer tracking information (e.g., cookie based, Internet-Protocol (IP) address based, as well as any other data collected on a customer, whether remotely or at the device used by the customer to interaction with the telecommunications service provider. The mobile device information may include, for example, but not be limited to, mobile call log data, mobile traffic data (e.g., websites visited), mobile location data (e.g., was customer device at competitor premises), and the like.

In some embodiments, method 400 may start at starting block 405 and proceed to stage 420, where platform 100 may receive data and compute features from balance replenishment history. Method 400 may then end at stage 430, where computing device 600 may provide features, as further described below. Nevertheless, methods consistent with embodiments of the present disclosure may be used with diverse input data by generating new predictive features.

In various embodiments, platform 100, during the feature calculation stage, may employ information, comprising, but not limited to:

Input data from the CDRs:
ID_CELL_START: The ID of the cell tower where the call is originated.
NUMBER_A: The number originating the call.
ID_CELL_END: The ID of the cell tower where the call is finished.
NUMBER_B: The destination number of the call.
TIMESTAMP: The timestamp of the beginning of the call.
DURATION: The duration of the call.
IMEI: An unique identification number of the phone terminal.
TYPE: Service identification, incoming call, outgoing call, incoming SMS, outgoing SMS.

Input Data From the Balance Replenishment History:
TIMESTAMP: The timestamp of the balance replenishment event.
NUMBER: The phone number related to the balance replenishment event.
AMOUNT: The amount of money the customer spent in the balance replenishment.
ACTIVATION_DAY: The day of the first balance replenishment.

With these input data, methods consistent with embodiments presented in this disclosure may be enabled to compute a monthly set of features for each customer. The set of generated features that may be calculated are, without exhaustion, enumerated below. In some embodiments, for example, the generated features may be used to train a random forest classifier. Random forest classifiers are supervised learning classifiers, meaning that the model learns from tagged examples or instances. The classifier may be trained, in a training phase 305, so that it can distinguish between churners and active customers based on features associated with them. In the embodiments presented herein, each instance refers to the features computed for each customer together with the known state in the following month (the tag class). The goal of training a model is to predict similar instances in the future (prediction phase 310).

V. Platform Feature List

A random forest may be comprised of hundreds or even several thousands of different decision trees generated from random sampling of the input features. Each decision tree may be generated from a random selection of a subset of m features using a sample of the training set. The subset of features m of each decision tree may be much smaller than the total number of features available for analysis. Each node of each decision tree provides a probability p (class|features)), which may be obtained during the training phase of the forest. To obtain the final predicted class of each instance a majority vote mechanism of all trees may be performed and the predicted label with the maximum likelihood is assigned. The majority voting mechanism may enable a selection of a class with the most votes.

In various embodiments, an ensemble of several supervised learning classifiers may be trained (e.g., random forest, neural networks, support vector machines, logistic regression) using the methods described above. In prediction phase 310, embodiments of the present disclosure may perform a majority vote mechanism of the prediction state of all the classifiers and the label with the majority class is obtained.

1. NUMBER: A unique customer identification.

2. ACTIVATION DAY: The customer activation date.

3. TOTAL_MONTHLY_TOPUPS: The number of balance replenishments made by the customer in that month.

4. TOTAL_MONTHLY_TOPUPS_FIRST_{—}5_DAYS: The number of balance replenishment events made by the customer in the first five days of the month.

5. TOTAL_MONTHLY_TOPUPS_LAST_{—}5_DAYS: The number of balance replenishment events made by the customer in the last five days of the month.

6. TOTAL_MONTHLY_CASH: The amount of cash spent in balance replenishment by the customer in that month.

7. TOTAL_MONTHLY_CASH_FIRST_{—}5_DAYS: The amount of cash spent in balance replenishment by that customer in the first five days of the month.

8. TOTAL_MONTHLY_CASH_LAST_{—}5_DAYS: The amount of cash spent in balance replenishment by that customer in the last five days of the month.

9. MIN_MONTHLY_CASH: Minimum amount of cash spent by the customer in a balance replenishment event that month.

10. MAX_MONTHLY_CASH: Maximum amount of cash spent by the customer in a balance replenishment event that month.

11. MEAN_MONTHLY_CASH: Mean amount of cash spent by the customer in all the balance replenishment events that month.

12. MEDIAN_MONTHLY_CASH: Median amount of the cash spent by the customer in all the balance replenishment events that month.

13. SD_MONTHLY_CASH: Standard deviation of the cash spent by the customer in all the balance replenishment events that month.

14. RANGE_MONTHLY_CASH: Difference among the maximum and minimum amount of cash spent by the customer in all balance replenishment events that month.

15. IQR_MONTHLY_CASH: Interquartile range of the cash spent by the customer in all the balance replenishment events that month.

16. MAD_MONTHLY_CASH: Mean Absolute Deviation of the cash spent by the customer in all the balance replenishment events that month.

17. MEAN_MONTHLY_TOPUPS_GAP: Mean of the elapsed time among all the balance replenishment events for that customer in the current month.

18. MAX_MONTHLY_TOPUPS_GAP: Maximum of the elapsed time among all the balance replenishment events for that customer in the current month.

19. MIN_MONTHLY_TOPUPS_GAP: Minimum of the elapsed time among all the balance replenishment events for that customer in the current month.

20. MEDIAN_MONTHLY_TOPUPS_GAP: Median of the elapsed time among all the balance replenishment events for that customer in the current month.

21. SD_MONTHLY_TOPUPS_GAP: Standard deviation of the elapsed time among all the balance replenishment events for that customer in the current month.

22. RANGE_MONTHLY_TOPUPS_GAP: Difference between the maximum and minimum of the elapsed time among all the balance replenishment events for that customer in the current month.

23. TOTAL_HISTORY_TOPUPS: Total number of balance replenishment made by the customer till current month.

24. TOTAL_HISTORY_CASH: Amount of cash spent by the customer till current month.

25. LAMBDA: An estimation of the frequency of balance replenishment events per customer in the current month.

26. P_LAMBDA: Assuming an exponential distribution for feature 25 (LAMBDA) and a power law distribution of feature 6 (TOTAL_MONTHLY_CASH), this feature gives the ratio between all scenarios where the customer accumulated more than the minimum allowed balance replenishment and the ones that customer does not reach the same threshold.

27. NUM_MOCS: Number of outgoing calls made by the customer that month.

28. INT_CALLS_MOC: Number of international calls made by the customer that month.

29. DIFF_START_END_CELLS_MOC: Number of outgoing calls where the cell tower of the beginning of the call is different than the cell tower of the end of the call.

30. TOTAL_DURATION_MOC: Total duration of outgoing calls from that customer in current month.

31. MEAN_DURATION_MOC: Mean duration of outgoing calls from that customer in current month.

32. MAX_DURATION_MOC: Maximum duration of outgoing calls from that customer in current month.

33. MIN_DURATION_MOC: Minimum duration of outgoing calls from that customer in current month.

34. SD_DURATION_MOC: Standard deviation of the duration of outgoing calls from that customer in current month.

35. CALLS_LT_{—}5_MOC: The number of outgoing calls with a duration less than five seconds for the customer in the current month.

36. MEAN_GAP_MOC_CALLS: Mean duration of the elapsed time among consecutive outgoing calls from that customer in the current month.

37. MAX_GAP_MOC_CALLS: Maximum duration of the elapsed time among consecutive outgoing calls from that customer in the current month.

38. MIN_GAP_MOC_CALLS: Minimum duration of the elapsed time among consecutive outgoing calls from that customer in the current month.

39. MEDIAN_GAP_MOC_CALLS: Median duration of the elapsed time among consecutive outgoing calls from that customer in the current month.

40. SD_GAP_MOC_CALLS: Standard deviation of the elapsed time among consecutive outgoing calls from that customer in the current month.

41. SUM_DURATION_TOP3_MOC: Total duration of the largest three outgoing calls per customer in that month.

42. CALL_DIVERSITY_MOC: Unique numbers from the customer has outgoing calls for that month.

43. CALL_DIVERSITY_MOC_PROB: This feature is computed as CALL_DIVERSITY_MOC divided by NUM_MOCS.

44. UNIQUE_CELLS_INI_MOC: Unique cell towers from where the customer made outgoing calls that month.

45. UNIQUE_CELLS_INI_MOC_PROB: This feature is computed as UNIQUE_CELLS_INI_MOC divided by NUM_MOCS.

46. CALLS_WORKHOURS_MOC: Number of outgoing calls during workhours (from 6:00 to 18:00, Monday to Friday) for that customer in the current month.

47. CALLS_WEEKDAYS_MOC: Number of outgoing calls during weekdays for that customer in the current month.

48. CALLS_WEEKEND_MOC: Number of outgoing calls during weekend for that that customer in the current month.

49. DURATION_WORKHOURS_MOC: Duration of outgoing calls during workhours (from 6:00 to 18:00, Monday to Friday) for that customer in the current month.

50. DURATION_WEEKDAYS_MOC: Duration of outgoing calls during weekdays for that customer in the current month.

51. DURATION_WEEKEND_MOC: Duration of outgoing calls during weekend for that customer in the current month.

52. P_I0_MOC: The likelihood of making a call from 23:00 to 6:00 for that customer in the current month.

53. P_I1_MOC: The likelihood of making a call from 6:00 to 12:00 for that customer in the current month.

54. P_I2_MOC: The likelihood of making a call from 12:00 to 15:00 for that customer in the current month.

55. P_I3_MOC: The likelihood of making a call from 15:00 to 19:00 for that customer in the current month.

56. P_I4_MOC: The likelihood of making a call from 19:00 to 23:00 for that customer in the current month.

57. NUM_MTCS: Number of incoming calls for that customer in the current month.

58. DIFF_START_END_CELLS_MTC: Number of outgoing calls where the cell tower of the beginning of the call is different than the cell tower of the end of the call.

59. TOTAL_DURATION_MTC: Total duration of incoming calls for that customer in the current month.

60. MEAN_DURATION_MTC: Mean total duration of incoming calls for that customer in the current month.

61. MAX_DURATION_MTC: Maximum duration of incoming calls for that customer in the current month.

62. MIN_DURATION_MTC: Minimum duration of incoming calls for that customer in the current month.

63. SD_DURATION_MTC: Standard deviation of incoming calls for that customer in the current month.

64. CALLS_LT_{—}5_MTC: Number of incoming calls less than five seconds for that customer in the current month.

65. MEAN_GAP_MTC_CALLS: Mean duration of the elapsed time among consecutive incoming calls from that customer in the current month.

66. MAX_GAP_MTC_CALLS: Maximum duration of the elapsed time among consecutive incoming calls from that customer in the current month.

67. MIN_GAP_MTC_CALLS: Minimum duration of the elapsed time among consecutive incoming calls from that customer in the current month.

68. MEDIAN_GAP_MTC_CALLS: Median duration of the elapsed time among consecutive incoming calls from that customer in the current month.

69. SD_GAP_MTC_CALLS: Standard deviation of the elapsed time among consecutive incoming calls from that customer in the current month.

70. SUM_DURATION_TOP3_MTC: Total duration of the largest three outgoing calls per customer in that month.

71. CALL_DIVERSITY_MTC: Unique numbers from the customer incoming calls for that month.

72. CALL_DIVERSITY_MTC_PROB: CALL_DIVERSITY_MTC divided by NUM_MTCS.

73. UNIQUE_CELLS_INI_MTC: Unique cell towers from where the customer has incoming calls that month.

74. UNIQUE_CELLS_INI_MTC_PROB: This feature is computed by using UNIQUE_CELLS_INI_MTC divided by NUM_MTCS.

75. CALLS_WORKHOURS_MTC: Number of incoming calls during workhours (from 6:00 to 18:00, Monday to Friday) for that customer in the current month.

76. CALLS_WEEKDAYS_MTC: Number of incoming calls during weekdays for that customer in the current month.

77. CALLS_WEEKEND_MTC: Number of incoming calls during weekend for that customer in the current month.

78. DURATION_WORKHOURS_MTC: Total duration of incoming calls during workhours (from 6:00 to 18:00, Monday to Friday) for that customer in the current month.

79. DURATION_WEEKDAYS_MTC: Total duration of incoming calls during weekdays for that customer in the current month.

80. DURATION_WEEKEND_MTC: Total duration of incoming calls during weekend for that customer in the current month.

81. P_I0_MTC: The likelihood of an incoming call from 23:00 to 6:00 for that customer in the current month.

82. P_I1_MTC: The likelihood of an incoming call from 6:00 to 12:00 for that customer in the current month.

83. P_I2_MTC: The likelihood of an incoming call from 12:00 to 15:00 for that customer in the current month.

84. P_I3_MTC: The likelihood of an incoming call from 15:00 to 19:00 for that customer in the current month.

85. P_I4_MTC: The likelihood of an incoming call from 19:00 to 23:00 for that customer in the current month.

86. DAYS_SINCE_ACTIVATION: Elapsed days since the activation for that customer at the end of the current month.

87. NUM_ENTERS: Total number of times the customer changed from inactive to active state since the activation day.

88. NUM_EXITS: Total number of times the customer changed from active to inactive state since the activation day.

89. DAYS_WITHOUT_TOPUPS: Total number of days without doing a balance replenishment for each customer.

90. DAYS_ACTIVE: Total number of days the customer have been in active state in the last period.

91. STATE: State of the customer (active or inactive) at the end of the current month.

92. STATE_NEXT_MONTH: State of the customer (active or inactive) at the next month (tag class). This feature may be available in the training phase.

VI. Advantages of the Churn Prediction Platform

Embodiments of the present disclosure provide platform 100 that may be resistant to overfitting and generalize well to new data as it can be shown from the experiments. The method may enable forecasting inactive customers with several days in advance.

Embodiments of the present disclosure further provide a predictive performance of random forests. In contrast to other supervised classification algorithms, such as support vector machines (SVMs) or Neural Networks (NN), random forests have reasonable computing times in training and prediction phases. This advantage may be observed in some embodiments of the disclosure employing random forest classifiers.

Combining classifiers in an ensemble is often more accurate than using individual classifiers and, in turn, may increase diversity. Two different classifiers may be considered diverse if they make different errors on new data points. By combining different classifiers in an ensemble that uses a voting mechanism, uncorrelated errors by diverse classifiers can be eliminating as disclosed herein.

Embodiments of the present disclosure were evaluated over ten months of real data. During this period, nine models were trained and generated predictions for eight months. With month m1 and the customer state at the end of month m2, predictive model p1 was generated. Predictive model p1 generated predictions for the end of month m3 using the feature data of month m2.

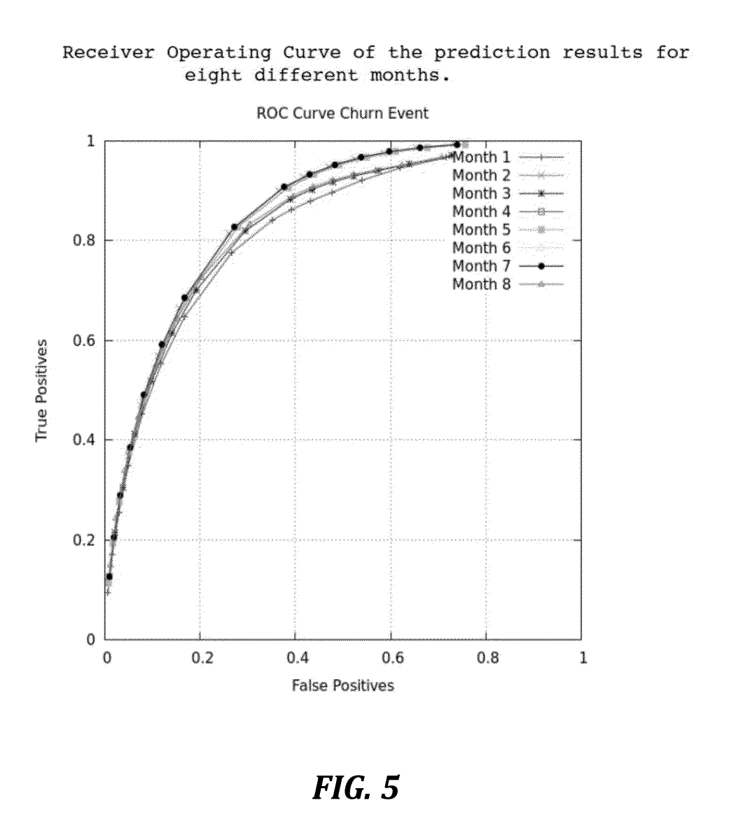

FIG. 5 shows results of the Receiver Operator Curve (ROC) churner's prediction for each of the eight months. The output of the predictive model is a score (between 0 and 1) that indicates the likelihood of the customer in churning. In FIG. 5, the ratio of False Positives (FP) against True Positives (TP) of the predicted churners is represented. TP indicates the correctly predicted churners; FP refers to a customer wrongly predicted as churner but who did not churn. Experiments show that the model is quite stable along different months. Thus, it generalizes well with future instances and does not overfit the training data.

VII. Platform Architecture

Computing device 600 may comprise, but not be limited to, a desktop computer, laptop, a tablet, or mobile telecommunications device. Although methods 200-400 have been described to be performed by a computing device 600, it should be understood that, in some embodiments, different operations may be performed by different networked elements in operative communication with computing device 600.

Embodiments of the present disclosure may comprise a system having memory storage and a processing unit. The processing unit coupled to the memory storage, wherein the processing unit is configured to perform the stages of methods 200-400.

FIG. 6 is a block diagram of a system including computing device 600. Consistent with an embodiment of the disclosure, the aforementioned memory storage and processing unit may be implemented in a computing device, such as computing device 600 of FIG. 6. Any suitable combination of hardware, software, or firmware may be used to implement the memory storage and processing unit. For example, the memory storage and processing unit may be implemented with computing device 600 or any of other computing devices 618, in combination with computing device 600. The aforementioned system, device, and processors are examples and other systems, devices, and processors may comprise the aforementioned memory storage and processing unit, consistent with embodiments of the disclosure.

With reference to FIG. 6, a system consistent with an embodiment of the disclosure may include a computing device, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include prediction application 620. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., prediction application 620) may perform processes including, for example, one or more methods' stages as described above. The aforementioned process is an example, and processing unit 602 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

VIII. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving customer activity data;
computing features associated with the customer activity data;
predicting customer churn based on the computed features using at least one statistical machine learning models; and
providing a report indicating customer churn predictions.

2. The method of claim 1, wherein receiving customer activity data comprises receiving customer activity data in the form of mobile data logs.

3. The method of claim 1, wherein employing the at least one machine learning classifier comprises generating a plurality of decision trees.

4. The method of claim 3, wherein generating the plurality of decision trees comprises utilizing a random sampling of the features.

5. The method of claim 4, further comprising calculating a probability for each node of the decision tree based at least in part on the features.

6. The method of claim 5, furthering comprising obtaining a prediction for each class of features by a majority vote.

7. The method of claim 5, furthering comprising assigning a likelihood of customer churn based on the majority vote.

8. The method of claim 1, further comprising performing a training phase to establish a training model.

9. The method of claim 8, wherein performing the training phase comprises establishing a training set of features.

10. The method of claim 1, wherein providing predictions comprises providing predicted customer churn for mobile telecommunication device customers in a telecommunications service provider's network.

11. The method of claim 1, wherein computing the features comprises computations utilizing at least one of the following methods:
a random forest algorithm;
a neural network;
a support network; and
a logistic regression.

12. A computer readable storage unit having executable instructions stored therein which, when executed by a computing device, perform a method comprising:
receiving customer activity data;
computing features associated with the customer activity data;
predicting customer churn based on the computed features; and
providing a report indicating customer churn predictions.

13. The computer readable storage unit of claim 12, wherein receiving the customer activity data comprises receiving data comprising customer activity.

14. The computer readable storage unit of claim 12, wherein receiving the customer activity data comprises receiving at least one of the following: a Call Detail Record (CDR) and balance history of a plurality of customers.

15. The computer readable storage unit of claim 14, wherein receiving the CDR comprises receiving details about each call made by the plurality of customers, when the call was made, and duration of the call.

16. The computer readable storage unit of claim 12, wherein providing predictions comprises providing predicted customer churn for mobile telecommunication device customers in a telecommunications service provider's network.

17. The computer readable storage unit of claim 10, wherein computing the features comprises computations utilizing at least one of the following:
a random forest algorithm;
a neural network;
a support network; and
a logistic regression.

18. The computer readable storage unit of claim 17, wherein utilizing the random forest algorithm comprises selecting an optimal setting by receiving a plurality of votes from a plurality of decision trees and selecting a class with a greatest number of votes.

19. The computer readable storage unit of claim 18, wherein utilizing the random forest algorithm further comprises:
receiving feedback from accuracy of past predictions; and
adjusting the algorithm to incorporate the feedback.

20. The computer readable storage unit claim 12, wherein performing the training phase comprises establishing a training set of features.
